(19) United States
(12) Patent Application Publication
(10) Pub. No.: US 2023/0245144 A1
(43) Pub. Date: Aug. 3, 2023

(54) SYSTEM FOR IDENTIFYING AND PREDICTING TRENDS

(71) Applicant: Nichefire, Inc., Cincinnati, OH (US)

(72) Inventors: Michael Howard, Cincinnati, OH (US); Steven Brown, Portland, ME (US); Paul Kostoff, Cincinnati, OH (US)

(21) Appl. No.: 18/103,351

(22) Filed: Jan. 30, 2023

Related U.S. Application Data
(60) Provisional application No. 63/305,327, filed on Feb. 1, 2022.

(51) Int. Cl. G06Q 30/0201

(52) U.S. Cl. CPC G06Q 30/0201

(57) ABSTRACT

A system and method that automates trending data collection and timeseries predictions based on a coordinated system of emerging topics across social media, forums, news, media, search engine, web traffic, and other data sources. Using machine learning and natural language processing, trending data counts are cross referenced across each platform to inform representative conversational data collection, cultural classification, and timeseries predictions in order to identify emerging trends and predict trend trajectory over time. User interfaces provided by the system may be used to aid in evaluating emerging cultural trends as they may relate to business activity, law enforcement, and financial and other personal decisions, for example. The system may provide such data based on upon user configured searches that might focus the results on topics such as key consumer, economic, or political topics.

### PRIORITY

This application claims the priority of U.S. Provisional Patent 63/305,327, filed Feb. 1, 2022, and titled “System for Identifying and Predicting Trends,” the entire disclosure of which is incorporated herein by reference.

### FIELD

The disclosed technology pertains to a system for collecting, evaluating, and viewing data to identify and predict emerging trends.

### BACKGROUND

Online channels, like social media, search engines, web traffic, media, and online forums can be an effective way to monitor user and audience input, interest, and influences across numerous topics. By collecting data on online human inputs (e.g., likes, comments, shares, search interest, web views) a business can track the platforms that drive a cultural trend, event, or narrative. Many channels and other information sources allow users to engage in some sort of research, engagement with other users, or engagement with current events. Such resources, and the data they consolidate, may be used by an individual or business to plan their activities and growth, understand potential trends they may be able to act upon, innovate products and services, develop marketing (e.g., advertisements, but also personal marketing such as resumes), and to provide guidance in other activities.

While some businesses and individuals monitor consumer behaviors and trends using various manual activities and isolated technology features (e.g., search engine keyword alerts), there is a need for an intuitive solution that uses online conversational data and artificial intelligence to help users identify and predict trends that will make an impact on their business or personal activities. Conventional technologies are ineffective at this because they require considerable manual configuration and/or effort by a user, and often the user is unable to properly configure the system to identify an emerging trend until the trend has already run its course (e.g., keyword alerts are ineffective at identifying an emerging trend, because it is difficult to choose meaningful keywords prior to actual identification of the trend).

As another weakness of current approaches, using conventional technologies a business may set up teams to evaluate search engine data pertaining to their brand and topics of interest and social data pertaining to consumer activities they are interested in. However, since these data sources are disparate and/or isolated systems and datasets, it is difficult to identify correspondences between these data sources (e.g., identify which platforms impact other platforms and how they impact the trajectory of trends and consumer behavior, both between platforms and globally).

Accordingly, there is a need to create an efficient and user-friendly way for users to evaluate and identify emerging consumer, economic, political, and other trends pertaining to their personal or business goals, and to capture the unique benefit of predicting the future trajectory of those trends so that they may be able to extrapolate strategic insights and action steps based thereon.

### BRIEF DESCRIPTION OF THE DRAWINGS

The drawings and detailed description that follow are intended to be merely illustrative and are not intended to limit the scope of the invention as contemplated by the inventors.

FIG. 1 is an architectural diagram of a system configured to identify and predict trends.

FIG. 2A is a flowchart of a set steps that could be performed with a system to collect multi-channel trend data.

FIG. 2B is a flowchart of a set steps that could be performed with a system to collect representative data based on multi-channel trend data.

FIG. 3 is a flowchart of a set steps that could be performed with a system to classify trend data into cultural categories.

FIG. 4 is a flowchart of a set steps that could be performed with a system to provide a cultural classification model configured to perform steps such as those of FIG. 3.

FIG. 5 is a flowchart of a set steps that could be performed with a system to cluster conversational data based on similarity.

FIG. 6 is a flowchart of a set steps that could be performed with a system to perform clustering, and may be performed during steps such as those of FIG. 5.

FIG. 7 is a flowchart of a set steps that could be performed with a system to evaluate a trend to determine certain metrics and sentiment.

FIG. 8 is a flowchart of a set steps that could be performed with a system to provide predictive analysis of trend trajectory.

FIG. 9 is a flowchart of a set steps that could be performed with a system to provide timeseries prediction modeling, and may be performed during steps such as those of FIG. 8.

FIG. 10 is a flowchart of a set steps that could be performed with a system to identify and recommend trends to particular users based upon their user configurations.

FIG. 11 is a flowchart of a set of high level steps that could be performed with a system to identify and predict trends.

FIGS. 12A through 12F each provide examples of user interfaces that may be provided to a user of a system.

### DETAILED DESCRIPTION

The inventors have conceived of novel technology that, for the purpose of illustration, is disclosed herein as applied in the context of collecting, evaluating, and viewing data to identify and predict emerging trends. While the disclosed applications of the inventors' technology satisfy a long-felt but unmet need in the art of collecting, evaluating, and viewing data to identify and predict emerging trends, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

Implementations of the disclosed technology may be used to enhance and syndicate datasets in a way that provides users with a multi-channel view of human activity and recommends trends to the user based on favorable predictions and the relevancy of user inputs. The insight and foresight given from the technology allows users to identify the trajectory of a potential trend will enhance business decision-making system by indicating trends they should either take advantage of or avoid. For example, if a business is making a decision related to developing or releasing a new product or feature, they can search and/or monitor for related trends that might influence their decision making (e.g., an emerging trend that illustrates rising demand for a particular product might be the basis for accelerating the development or release of a similar product). The features and data provided by implementations of the disclosed technology may also be used to back test against their own internal datasets to develop more focused or intuitive predictions.

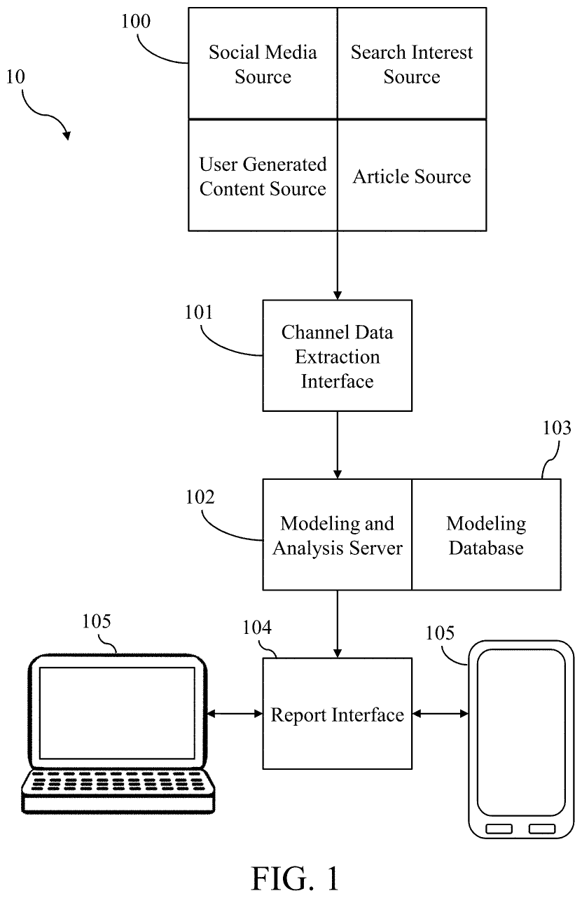

Turning now to the figures, FIG. 1 is an architectural diagram of a system (10) configured to identify and predict trends. A modeling and analysis server (102) is in communication with a plurality of channels (100) via a channel data extraction interface (101) that allows the server (102) to monitor and collect data from the channels (100). The channels (100) may be online or cloud based data sources and repositories of information, and may include, for example, social media sites, search interest data from search engines, user generated content (e.g., comments, product reviews, forum posts), articles (e.g., news articles, product review articles), and other platforms, channels, and data sources. Each of these channels represent a data type that is reflective of the nature of user interactions with the particular channel, and may be dictated by high-traffic keywords, hashtags, articles, news headlines, and communities, for example.

The evaluated data from each of the channels then inform an automated data collection interface (101) that is configured to collect a weighted representative amount of conversational data across each channel (100). This data is then processed and synthesized, by the server (102), through a series of classification and clustering systems that evaluate the qualitative variables in the datasets and indexes the nature of these outputs, with the results and input being stored in a database (103). Then, for each of the trend inputs from hashtags, clusters, and high-traffic topics, the server (102) may perform timeseries predictions for each of the quantitative variables that are indicative of a predicted trajectory. Relevant predictions are identified based upon user configurations and then synthesized into a reporting interface (104) that describes relevant trends, trend analysis results, and related recommendations. The reporting interface (104) may be provide to a user via a user device (105), which may be, for example, a computer, mobile device, smartphone, tablet, or other computing device, and may be provided via a website, API, native software application, or other interface or channel.

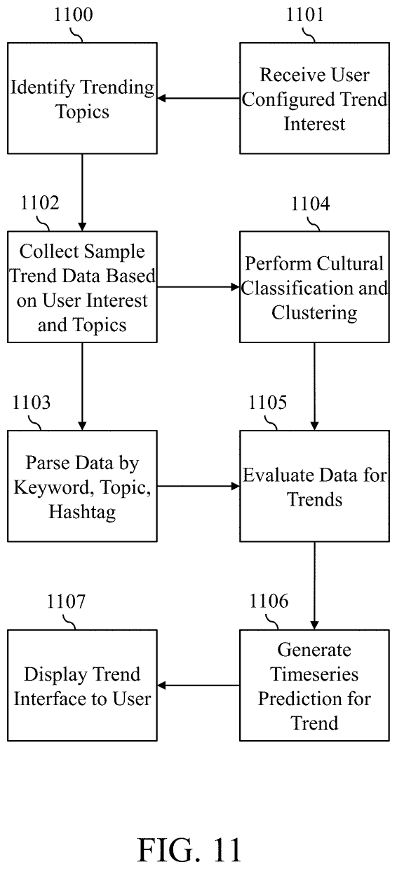

FIG. 11 provides a high-level description of the process that the system (10) is configured to perform, which steps include identifying (1100) trending topics based upon a user's configured (1101) trend interest, collecting (1102) sample trend data, parsing, organizing, or separating (1103) the data by keywords, topics, hashtags, or other classification, performing (1104) cultural classification and clustering on the data, and evaluating (1105) trends represented in the data. The system may then generate (1106) timeseries predictions for the identified and evaluated trends, and may provide the results of analysis by displaying (1107) a trend interface to the user that shows the results and breakdowns served.

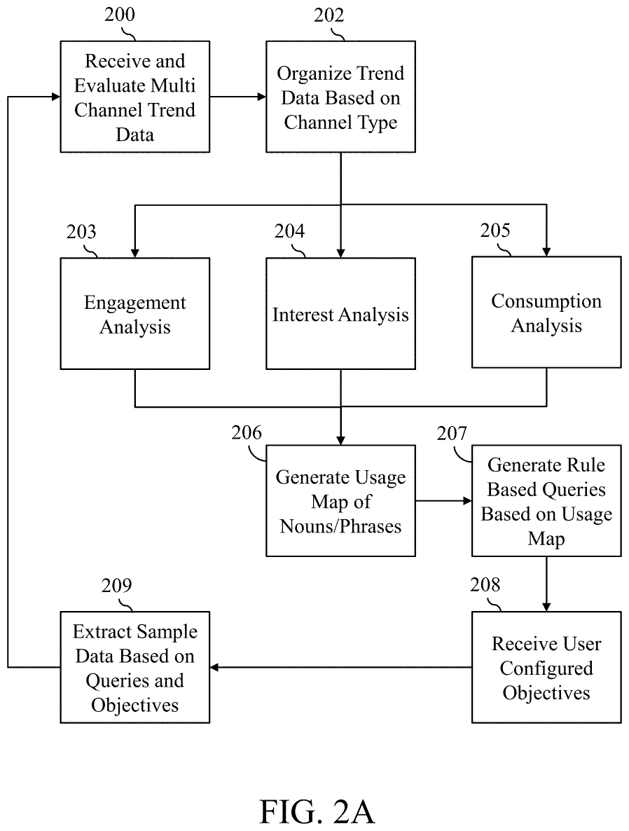

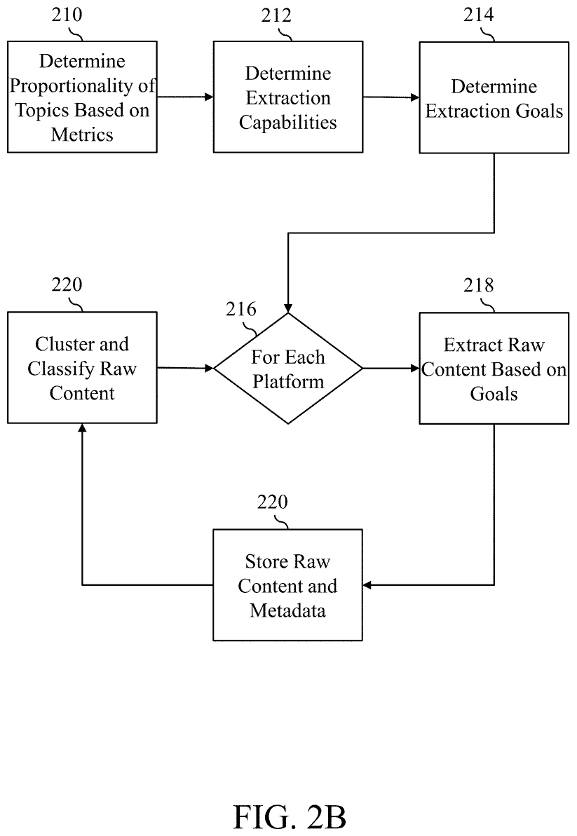

FIG. 2A is a flowchart of a set steps that could be performed with a system to collect multi-channel trend data. In some implementations, the disclosed system uses a daily inflow of data from channels and data sources that continuously informs the system of growing and changing trends. The system may be configured to perform general or global trend evaluation, and may also be configured by a particular user to provide results that are customized for that user (208). After receiving (200) trend data from the multiple queried channels, the system may organize (202) portions of the trend data into unique categories based upon the channel type from which it was received. Received (200) trend data may include information provided by the platform via an API that may indicate popular or trending topics on the platform, and may include identification of a topic, a description of a topic, and a count, volume, magnitude, or other metric describing the topic in relation to other topics. As an example, received (200) trend data from a social media such as Twitter may identify trending hashtags, and may include data describing the count or magnitude of hash tag usage (e.g., a particular hashtag may be “#superbowl”, and a count for the hashtag usage may indicate 100,000 unique messages), while trend data for a search engine such as Google may identifying popular search topics and an underlying count (e.g., a particular search may be “superbowl”, and a count for the search may indicate 100,000 unique searches). Different evaluations may then be performed on the data depending on the category in which a particular portion is organized. Category based evaluation may include evaluation of engagement channel data (203) (e.g., social media comments and content, forum posts, blog activity, and user generated content from other platforms where users engage with one another), evaluation of interest channel data (204) (e.g., search engine metrics, research activities, web traffic, and other content that demonstrates deliberate topic interest), and evaluation of consumption channel data (205) (e.g., one-sided content for consumption by media and/or influential entities, such as news articles and publications).

In some implementations, evaluation of channel data may include identifying and totaling activity that represents consumer interest for an emerging trends on that channel, and each channel may have a unique set of rules for identifying and totaling such activity. As an example, for engagement channel data, interest may be calculated based upon one or more of number of likes, number of comments, number of shares, and other factors. For interest channel data, interest may instead be calculated based upon one or more of search term frequency, day-to-day increase in searches, geographical distribution of searches, and other factors. For consumption channel data, interest may instead be calculated based upon one or more of article views, article shares, article domain, article presence on front page/other locations, and other factors.

After each channel is evaluated, the system may generate (206) a usage map that describes the frequency and use of nouns and/or phrases within the trend data for each channel. This may include all the common nouns in emerging topics and headlines. The usage map may be used to generate rule and keyword-based queries that may be used to collect a representative sampling of conversational data using API connectors into textual databases and online channels (207). The system may also receive (208) user configured objectives as inputs, which may be used to guide future collection of data. As an example, a user's configured objectives might influence the channels from which data is received (200), or might influence the weighted value given to certain activities on certain channels, or may influence other aspects of the evaluation. The steps of FIG. 2A may be repeated continuously and/or based on a schedule. Generated (207) queries and user configured objectives (208) may be used to extract (209) representative sample data from the platforms from which the initial trend data was received.

FIG. 2B shows a set of steps that may performed with a system to extract representative sample data based on received (200) and analyzed trend data. Due to the vast amount of information that is continuously created and transmitted on the internet, it is not feasible to gather and analyze all possible data and content that is indicative of trends, as the requirements for storage, network traffic, and processing would far exceed the capabilities of an individual actor. Implementations of the disclosed system address this limitation by first identifying at a high level the trending topics on a platform (e.g., such as described in the context of FIG. 2A) based upon a high level analysis of the platform content or, in some cases, first-party trend data that the platform itself provides via API or a website location (e.g., such as Twitter trending topics and counts, Google search term frequency counts, etc.).

Based on this data, the system may determine (210) a proportionality for the trending topics based on the available metrics (e.g., hashtag counts, search counts, like counts, etc.). As one example, where a platform provides data and counts for the top five trending topics on that platform, including an aggregate count across the five topics of 1,000,000 units (e.g., individual hashtags, likes, searches, etc.), and the overall top trending topic accounts for 50% of the aggregate, that topic might be proportionally rated to influence eventual content extraction (e.g., if gather representative data based on these topics, the system may aim to gather sample data proportionally to the determined (210) proportions). The system may then determine (212) current extraction capabilities either across all platforms, or for a particular platform. Extraction capabilities may be limited by, for example, storage capability, network capability, processing capability, or in some cases, may be limited by the platforms themselves in some manner (e.g., a particular API for searching individual comments on a platform may limit queries to retrieve comments to 10,000 per query or time interval).

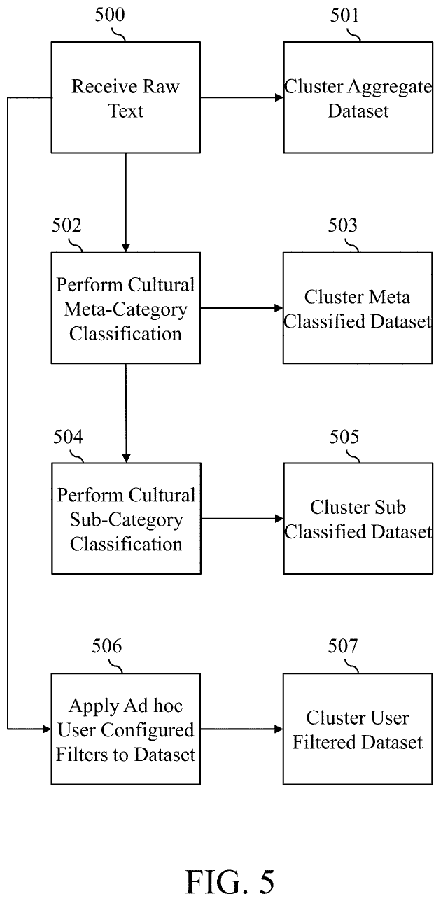

Based on the determined (210) proportionality and extraction capabilities (212), the system may determine (214) a set of extraction goals for extracting sample data from the platforms. For each platform (216) the system may then extract (218) (e.g., via API, crawling, or other query) underlying content based on the extraction goals. The raw extracted content may be stored (220) along with any associated metadata. The system may also, as will be described in more detail below, cluster and classify (220) this raw underlying content (e.g., such as shown and described in the context of FIG. 5). Table 1 below provides an example of a set of trending topics identified on a particular platform, or across platforms, as well as determined proportionalities and extraction goals. As can be seen, such an approach may reduce the total traffic on a particular topic from tens or hundreds of millions of individual comments to a subset of thousands of representative comments that are still very representative of the overall development of trends on that platform. By vastly reducing the system requirements for each such query (e.g., from the unreasonable goal of capturing and storing all comments) the system is able to perform this more manageable task multiple times per day or week, and is able to store (220) and retain the raw underlying data for prolonged periods of time.

TABLE 1
Exemplary Trending Topic Proportionality and Extraction Goals

| | Proportion of Aggregate | Extraction Goal |
|---|---|---|
| Topic | (1,000,000 total hashtag) | (10,000 total comments) |
| #superbowl | 500,000 | 5,000 |
| #crypto | 150,000 | 1,500 |
| #inflation | 150,000 | 1,500 |
| #cats | 100,000 | 1,000 |
| #overtime | 100,000 | 1,000 |

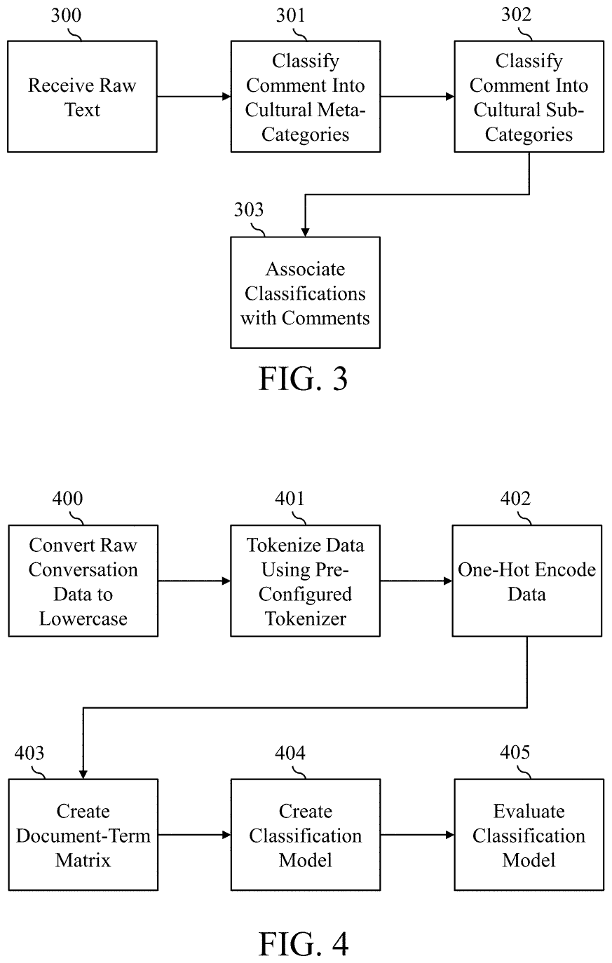

FIG. 3 is a flowchart of a set steps that could be performed with a system to classify trend data into cultural categories. After receiving (300) raw text (e.g., typically comments or other user generated text content, extracted as a representative sampling as illustrated in FIG. 2B), the system may associate portions of the data with certain cultural attributes. In some implementations, the cultural attribute classifiers are supervised classification systems using transformer natural language processing technologies. During this classification, a portion of raw text (e.g., a single comment) may be first assessed based on the cultural attributes present in the qualitative data, which the classification system identifies and tags. The classification system has two levels of classification; the first being a meta categorization system that identifies and classifies (301) the high-level cultural attributes of a human interaction with the internet (e.g., a comment, forum post, like, upvote, etc.). This data is then processrf through a secondary classification system that identifies and classifies (302) into cultural sub-categories. These sub-categories are respectively assigned exclusively to one meta category. As they are determined, meta categories and sub categories may be saved and associated (303) with the comment or other raw text. For example, a comment's cultural meta category can be marked as Industry & Business, then its respective cultural sub-category within the Industry & Business library could be Markets & Economy. The number and type of cultural meta categories may vary (e.g., Market and Economics, Arts and Entertainment), but a larger number of meta categories supports finer user search and data viewing capabilities. Similarly, cultural sub-categories provide more fine tuning of user search and data viewing capabilities, and so the number and variety of sub-categories may vary by meta-category (e.g., a Market & Economics meta-category may have tens of sub-categories such as Stock Market, Employment, Cryptocurrency, United States, International, etc.).

FIG. 4 is a flowchart of a set steps that could be performed with a system to provide a cultural classification model configured to perform steps such as those of FIG. 3. The steps begin with the raw post content being converted (400) into lowercase and tokenized (401) using whitespace to separate words from quotes and ending punctuation marks, which may include using a pre-trained or otherwise pre-configured tokenizer, and is then combined in a dataframe or other data structure containing a column for data type. Before training, the comment or other raw data text column is one-hot encoded (402). The content column containing tokenized raw text is converted to create (403) a document-term matrix, which may be performed using a tf-idf weighting scheme or another similar method, and with the removal of stopwords. The transformation may be done using a language such as the python open-source “TfidfVectorizer” library from the sklearn package, or another library having similar capabilities. The data may be used to create (404) a classification model, which may include, as an example using a neural network machine learning algorithm which fits hyperdimensional continuous plains between categories. The created (404) model may be evaluated (405) by, for example, using 5-fold cross-validation to ensure that it achieves accuracies above 90% using approximately 40,000 rows of training data. Once evaluated (405), the model can be exported by being “pickled” so that it can be loaded into the data pipeline for production use.

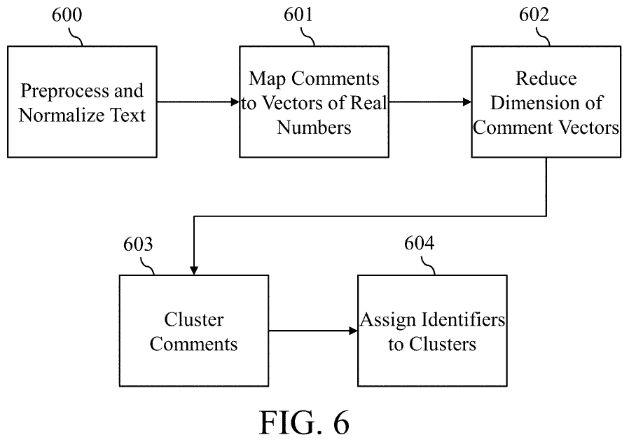

FIG. 5 is a flowchart of a set steps that could be performed with a system to cluster conversational data based on similarity. The purpose of clustering conversational data, or other data, is to evaluate emerging nuanced topics that may otherwise be difficult to build trained classifiers for. The clustering technology first receives (500) the raw text that has been classified for cultural meta categories and cultural sub categories. The total population of raw data is first clustered (501) using a word vectorization process, as described below in the context of FIG. 6. The data is then segmented by the meta categories (502) and disparately clustered (503) based on the respective classification in the cultural meta categories library. The raw data is then further segmented by cultural sub category (504) and disparately clustered (505) based on the respective classification in the cultural sub categories library. Separately, users may also run their own ad hoc clustering by first establishing filters for the dataset (506) and then executing the cluster after their filters have been established to cluster (507) the data based on ad hoc filtering. By producing three basic clustered datasets (e.g., clustered total dataset, clustered meta-category classified dataset, clustered sub-category classified dataset), and then considering these clusters in context with each other, the system is able to reduce undesirable characteristics within the data, and is able to more narrowly and directly guide unsupervised clustering and learning processes.

FIG. 6 is a flowchart of a set steps that could be performed with a system to perform clustering, and may be performed during steps such as those of FIG. 5. Initially, the system may preprocess (600) and normalize the text by, for example, standardizing to lower case, removing stopwords, punctuation, and other symbols, and lemmatizing to reduce verbs to their root. The system may map (601) the comment or other data to vectors of real numbers. In some implementations, initial vectors may include around 700 real numbers. Vectors may be determined through machine learning modeling to create word representations that yield similar vectors for similar words.

The system may reduce (602) the dimensions of the text vectors (e.g., by using a function such as Umap), because a clustering algorithm tends to produce more desirable results with a dimension of around 20, instead of the initial 700. After text is reduced in dimensions to an optimized value, the system may cluster (603) the text (e.g., using a function such as the DBSCAN algorithm. DBSCAN estimates the distance between points based on select inputs. In this case, the result means using the reduced vectors for each comment or other text. DB SCAN calculates proximity between comments and other text. As a result, comments and other text in close proximity are semantically similar given their vector representations. The system may then assign (604) identifiers to the resultant clusters, which may include manually or procedurally associating the clusters with intuitive names.

In some implementations, the clustering (603) yield cluster numbers from 0-n depending on how many clusters are produced. The system may be configured to procedurally rename those clusters by associating them with a locally unique identifier in the form of most frequently occurring words within each of the clusters, at lengths of 2-4 words, while ensuring/enforcing local uniqueness. The result is a more useful naming convention for clusters than arbitrary or sequential numbers.

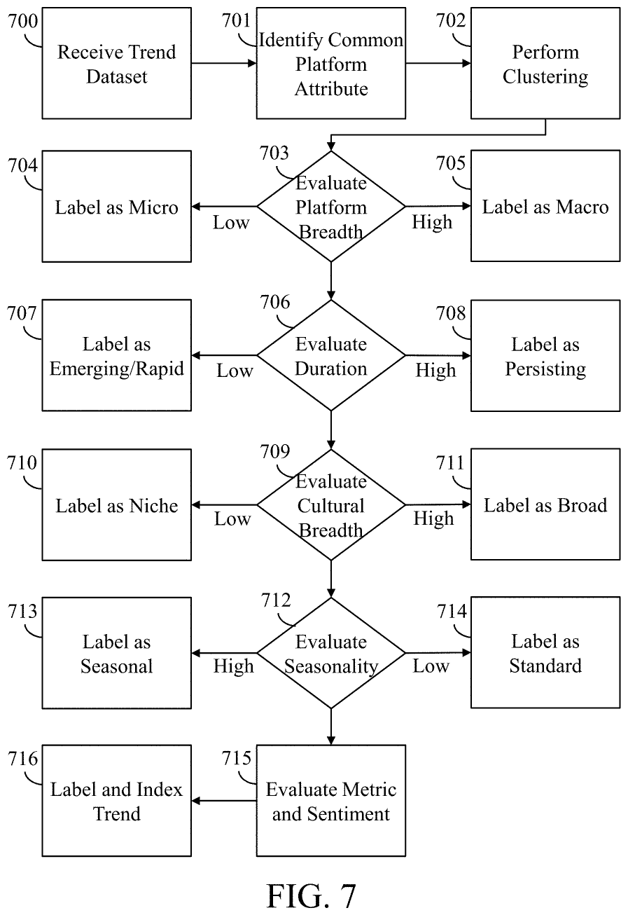

FIG. 7 is a flowchart of a set steps that could be performed with a system to evaluate a trend to determine certain metrics and sentiment and assign certain labels. Upon receiving a trend dataset (700) from a plurality of channels, the system may evaluate the text and identify (701) the common platform attributes and keywords, and perform (702) clustering and classification. The trend datasets are then segmented and labeled based on the qualitative nature of the trends. For each trend, the system may evaluate (703) the trends platform breadth based upon the number of distinct platforms or channels from which the trend dataset is derived, and may further characterize the trend based upon a pre-configured threshold that defines high or low platform breadth. Trends that have low platform breadth (e.g., trend dataset derived from two or less platforms) may be labeled (704) as Micro trends, while trends that have high platform breadth (e.g., derived from 3 or more platforms) may be labeled (705) as Macro trends.

The system may also evaluate (706) the duration of the trend based on the number of consecutive time periods (e.g., hour, days, weeks) in which the trend was identified as a trend, and may further characterize the trend as having a high or low duration depending upon a pre-configured threshold. Trends that have low duration (e.g., identified as a trend for less than three consecutive weeks) may be labeled (707) as Emerging or Rapid trends, while trends that have high duration (e.g., identified as a trend for greater than three consecutive weeks) may be labeled (708) as Persisting trends.

The system may also evaluate (709) the breadth of the trends cultural classifications, and may further characterize the trend as having a high or low cultural breadth depending upon a pre-configured threshold. Trends that have low cultural breadth (e.g., trend appears on between 1 and 3 cultural categories, classification and/or communities, such as distinct forums, sub-forums, etc.) may be labeled (710) as Niche trends. Trends that have high cultural breadth (e.g., appears on four or more cultural categories, classifications, and/or communities) may be labeled (711) as Broad trends.

The system may also evaluate (712) the seasonality of trends, and may further characterize trends based on whether they have a high or low correspondence to a seasonal or temporal factor, based upon an examination of historic trend data to determine if the trend tends to repeat somewhat predictably based on month or season. Trends that have a high seasonality (e.g., historically recur at specific periods of time in a year) may be labeled (713) as Seasonal trends, while trends that have a low seasonality (e.g., random/arbitrary occurrence not linked to time of year) may be labeled (715) as Standard trends.

Following these qualitative evaluations, the quantitative variables are accounted for, including volume, interest, page views, unique authors, and other measurable elements indicating consumer interest over time (715). The patterns within the qualitative and quantitative variables are labeled and indexed (716). The indexing of these trend evaluations allow the technology to reference and compare similar trends to further enhance predictions—so that the predictions are not solely relying on historical data. The labels and variables for these trends are also expected to adjust over time—for example, a rise and decline in interest volume over time is a natural trait of trends. The trend evaluation system relabels the trend at various stages, but the pattern of the trend is entirely indexed for comparison and reference with similar trends. In addition to being useful as part of trend analysis and prediction, the labels (704 through 714) applied to certain trends may be useful in communicating characteristics of those trends to users. For example, when providing a user a summary of recommended trends, the system may visually highlight (e.g., by varying color, text format, or other formatting, or by displaying in conjunction with certain visual icons) trends to indicate that they are Micro versus Macro, Emerging versus Persisting, and so on. Additionally, users may be able to search and or filter for trends having a certain label, for example, a user may only be interested in Macro-Emerging trends and so may only be recommended trends having those labels, or such designations may be used to further weight trends that are recommended to a user, for example, a user that is primarily interest in Macro-Emerging trends have such trends highly weighted and recommended over other trends that might objectively be considered “bigger” trends.

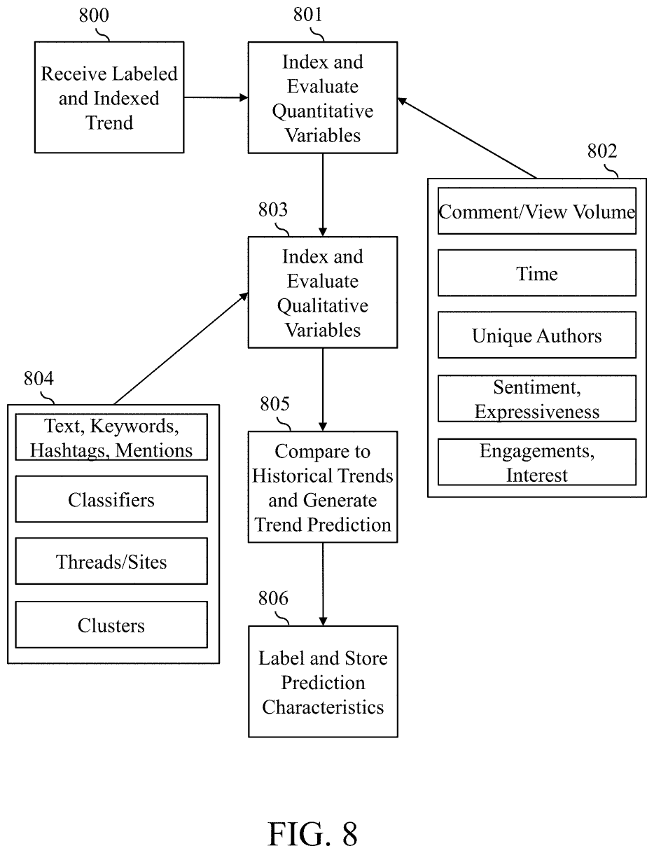

FIG. 8 is a flowchart of a set steps that could be performed with a system to provide predictive analysis of trend trajectory. The system may receive (800) labeled and indexed trends (e.g., such as described in the context of FIG. 7), and may evaluate (801) the trend based on its quantitative variables (802), which may include, for example, comment, view, like, or other volume, time, number of unique authors, sentiment, expressiveness, and any engagement or demonstration of interest. The indexed trends is then evaluated (803) for its qualitative attributes (804), which may include text data, classifiers, threads and sites, and clusters. A trend prediction may be generated (805) based on the historical data available for the trend, and the historical data available for trends that demonstrate similar qualitative and quantitative patterns. The prediction characteristics are then stored (806) and can be manually labeled and referenced to enhance future predictions of a similar nature.

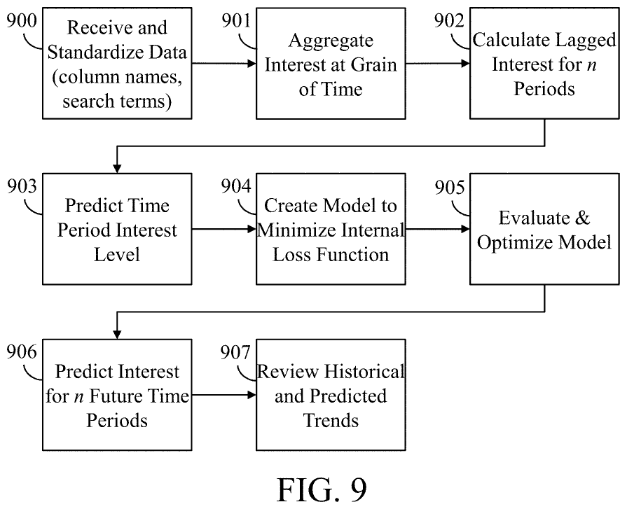

FIG. 9 is a flowchart of a set steps that could be performed with a system to provide timeseries prediction modeling, and may be performed during steps such as those of FIG. 8. The system may receive and standardize (900) data with respect to column names and search terms, and may aggregate (901) interest at a preferred grain of time (e.g., monthly, weekly, daily, etc.).

The system may then calculate (902) lagged trend interest for a given search term for n number of previous time periods. These lagged values become new columns in the modeling dataset. The system may then predict (903) trend interest for a given time period based on inputs such as n lagged interest values from predicted point (902), month of time period, season of time period, and other inputs. The system may also create (904) a model to minimize internal loss function for regression model architecture, which may include using a loss function such as RMSE which has been found to be particularly advantageous. The system may evaluate (905) and optimize this model for accuracy, and may compare predicted values versus observed values to determine goodness of fit. The system may then use this model to predict (906) interest for n future time periods of interest, which provides a predictive dataset that indicates the trend trajectory for a given topic. Based on the preceding, the system may then review (907) historical and predicted trends for each term used in the modeling, and may provide a visualization of the results.

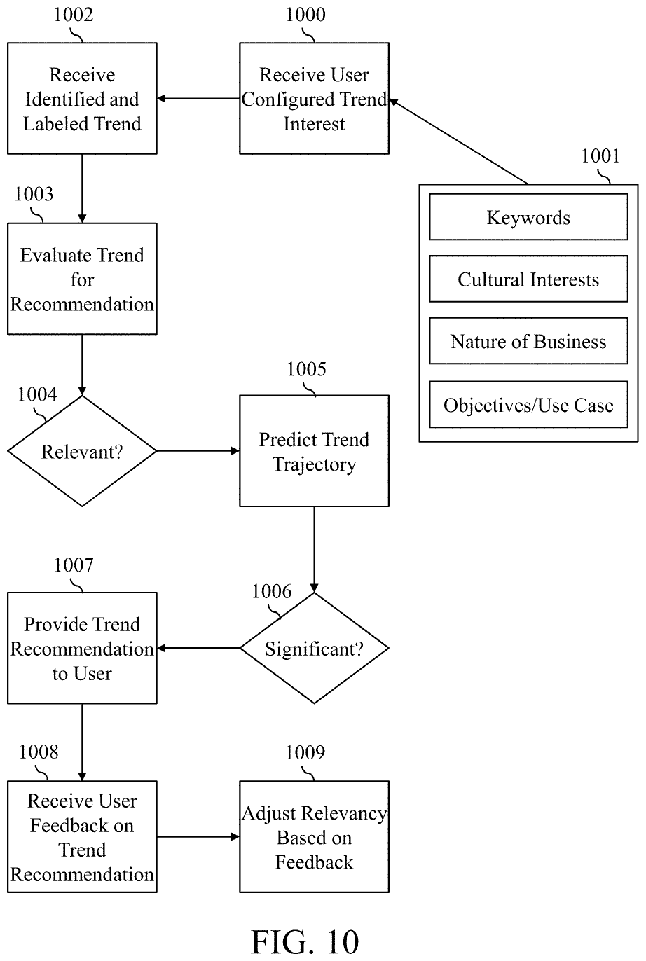

FIG. 10 is a flowchart of a set steps that could be performed with a system to identify and recommend trends to particular users based upon their user configurations. The system may receive (1000) inputs from the user, which may include keywords, cultural interests, the nature of their business, or outlined objectives and use cases (1001). Using the inputs from the user, a received (1002) labeled trend is evaluated (1003) for its relevancy to the user. If it is relevant (1004) to the user, the trend's trajectory is then predicted (1005). If the trend trajectory is projected to be significant (1006) or has a favorable outcome based on the user inputs, the trend is provided (1007) to the user via a user interface, as a device notification or alert, or both. The system may receive (1008) feedback from the user on a particular trend recommendation indicating whether they approve or disapprove of the suggested trend. The received feedback may then be used by the system to adjust the thresholds and rules for determining whether the trend is significant and/or relevant (e.g., positive feedback may result in evaluation for relevancy or significance being unchanged or somewhat reinforced, while negative feedback may result in evaluation for relevance or significance becoming more stringent).

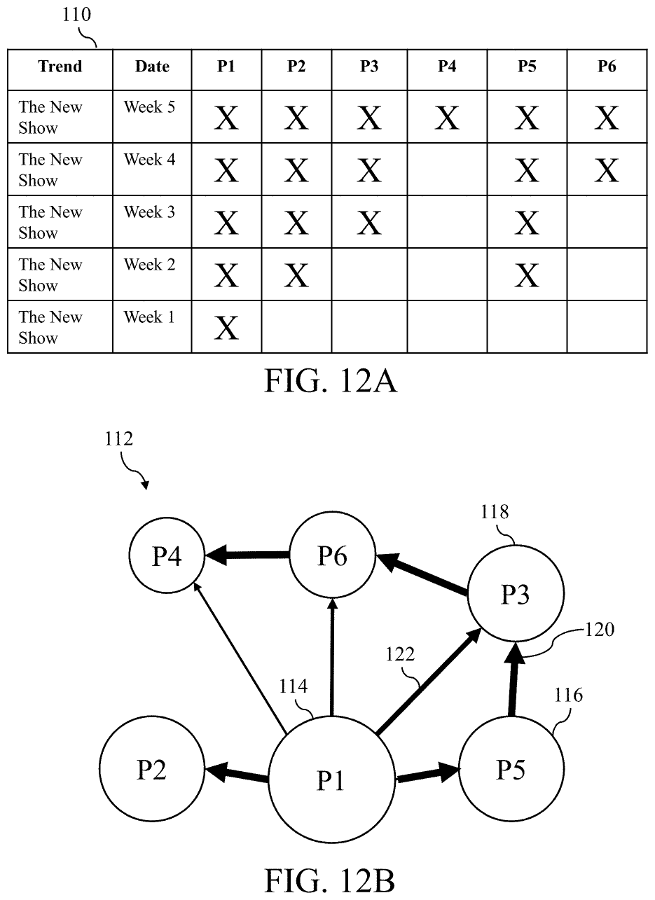

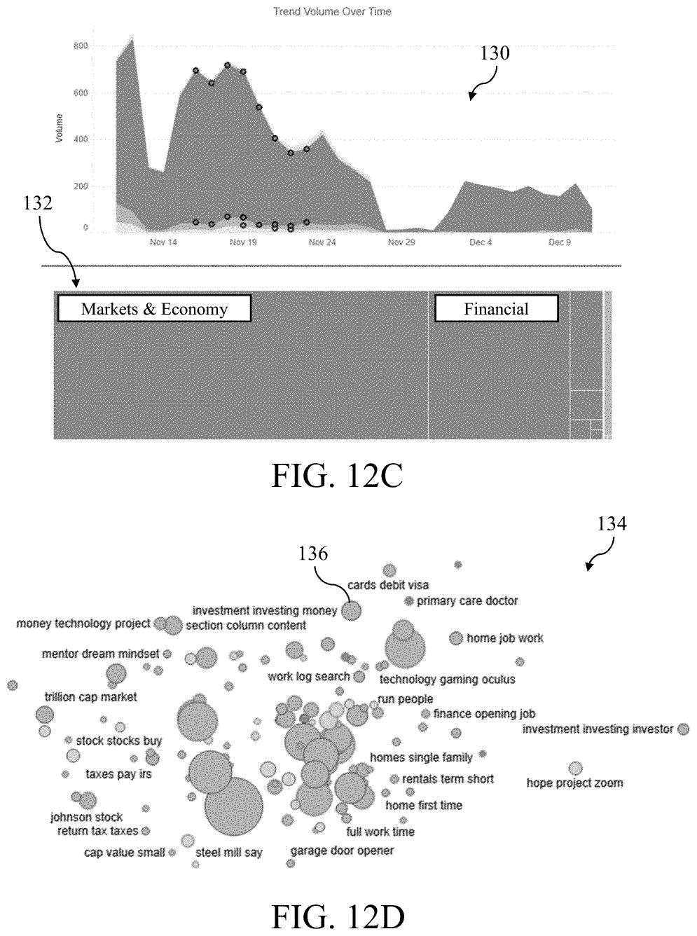

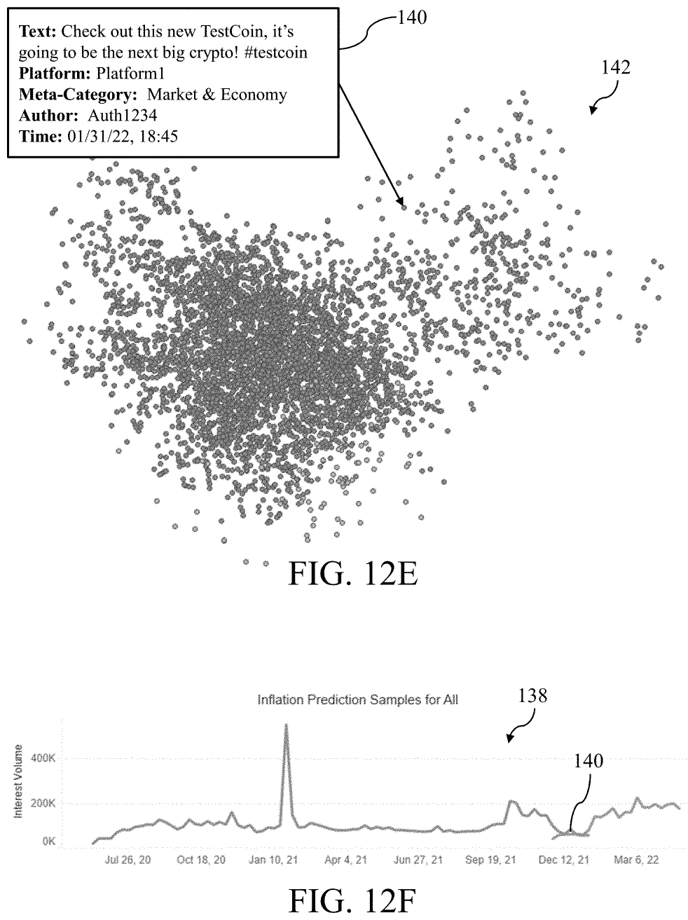

FIGS. 12A through 12F each provide example of user interfaces and data visualizations that may be provided to a user of the disclosed system, and that a user may interact with in order to navigate through and view different data. FIG. 12A shows a platform timeline (110) for a particular trend, and illustrates the weekly spread of the trend across a number of platforms (e.g., P1 through P6, where an X indicates that the trend was identified as trending on a particular week for a particular platform). In the example, the identified trend is “The New Show”, a video series released on platform P1 at Week 1, which is where it is initially seen as trending (e.g., based upon self-reported view numbers, user review, user likes, user comments, etc.). P2 and P5 are the next platform where the same trend is observed, P2 may be a forum that is dedicated to discussing video series releases on P1, while P5 might be a popular social medial platform without a particular discussion focus. By week 4 the topic is now trending on P3 and P6, which might be a digital or print publication that covers popular video entertainment and a second general use social media platform, respectively. Finally, by week 5 it can be seen that the topic is now trending on P4, which may be a publicly edited wiki where information is collected, edited, and published into article format.

The platform timeline (110) may be useful in comparing historic trends with emerging trends. For example, at a later time another video series might be released on P1, and might be identified as having similar trend patterns over 2 weeks (e.g., trending on P1, followed by trending on P2 and P5). By identifying this commonality, a user may determine that it is likely that the new video series will soon begin trending on P3 and P6, and may automatically or manually purchase advertising or marketing for the new video series on those platforms in anticipating of the future trend.

FIG. 12B is a cross-platform influence interface (112) that provides information similar to that in FIG. 12A, but additionally illustrates the estimated influence that each platform had on each other platform in pushing the trending topic. Cross platform influence may be determined by, for example, comparing trend activity for periods of time to see the extent to which spikes on one platform appear in another. Each platform is represented as a circle (e.g., or other shape) whose size or other visual characteristics may correspond to the duration of trend (e.g., topic has trended on P1 for five weeks), the magnitude of the trend interest on a platform, or other characteristics. Arrows (120, 122) may be rendered between platforms indicating areas where cross-platform influence is identified, and the size, color, or other visual characteristic of each arrow may indicate the extent of influence or other characteristics (e.g., a first arrow (120) being larger than a second arrow (122) may indicate that P5 is the primary platform driving interest in the topic to P3, while P1 is a secondary platform driving interest in the topic to P3).

FIG. 12C shows a high-level trend visualization that include a trend timeline (130) showing interest in the trend over time, and a cultural category summary (132) that proportionally shows the cultural categories that the underlying trend data is categorized into (e.g., meta-categories, sub-categories, such as described in the context of FIG. 3 and elsewhere). As an example, the trend timeline (130) illustrated in FIG. 12C may be for an “inflation” trend, and the cultural category summary (132) illustrates that the underlying data has been in the great majority classified as Market & Economy, and Financial, with several other smaller categories also implicated.

FIG. 12D shows a cluster map (134) of underlying data from FIG. 12C, and may be displayed when a user clicks on a particular cultural category (e.g., the user may click on “Markets & Economy” to narrow the view the underlying clustered data that is within the Markets & Economy cultural category). Each cluster (136) illustrated in FIG. 12D is shown with an automatically assigned name (e.g., such as when the system assigns (604) identifiers), and may be visually rendered with a different size, color, or other characteristic based upon the clustered data characteristics (e.g., a larger cluster may indicate volume of comments, while color may indicate positive or negative sentiment). Additionally, the spatial proximity of clusters to each other may indicate the word vector similarity between clustered datasets, as has been described above. This may be useful in helping users to identify outlier clusters (e.g., such as “hope project zoom”, distally present in the lower-right quadrant of the map) or closely related clusters (e.g., such as “money technology project” and “section column content”, present in the upper-left quadrant of the map), and provides an intuitive interface which a user may navigate by zooming in/out, scrolling along the x-y coordinates, and so on.

FIG. 12E shows a comment map interface (142), where each point on the map indicates one or more comments that were extracted as part of representative or sample data for the currently viewed topic. The comment map interface (142) may be navigated to by selecting a particular cluster from the cluster map (134) of FIG. 12D, for example. Comments rendered on the comment map (142) may be spatially related to other based upon word vector similarity, and may also be color coded to indicate characteristics such as cultural category. As with other interfaces, the user may zoom in and out, scroll along the x-y coordinates, and so on to view the relationships between visualized comments, and a user may also click on any individual comment visualization to see the raw data and metadata (140) extracted for that comment when retrieving representative or sample data, as has been described.

FIG. 12F shows a trend prediction interface (138) such as may be generated and rendered to a user when comparing and generating (805) a trend prediction. The trend prediction interface (138) may be viewed for any trend, and may show historical observations of the trend, future predictions for the trend, and a breakpoint (140) at which the observable and predicted data converge.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system for collecting and managing trend data comprising:
(a) one or more or processors;
(b) a channel extraction interface executed by the one or more processors and configured to receive data from a plurality of channels, and where the plurality of channels includes at least one social media channel;
(c) a data storage;
wherein the one or more processors are configured to:
(i) receive a trend dataset from the plurality of channels via the channel extraction interface, wherein the trend dataset describes, for each of the plurality of channels, one or more topics that are trending on that channel, and a trend measurement for each of the one or more topics on that channel;
(ii) determine a proportionality for each of the one or more topics based on the trend measurements for the one or more topics on that channel;
(iii) determine an extraction capability for each of the plurality of channels;
(iv) determine an extraction goal for each of the plurality of channels based on the proportionality and the extraction capability for each of the plurality of channels;
(v) for each of the plurality of channels, receive a trend content dataset from that channel via the channel extraction interface and based on the extraction goal for that channel, and store the trend content dataset in the data storage, wherein the trend content dataset comprises a representative sampling of content associated with the one or more trends on that channel;
(vi) determine a timeseries prediction for each of the one or more topics for a subsequent period of time; and
(vii) provide a trend interface dataset to a user device based on the timeseries predictions and the trend content datasets, wherein the trend interface dataset is usable to cause the user device to display a trend interface describing the timeseries predictions and the trend content datasets.

2. The system of claim 1, wherein the one or more processors are further configured to, for each channel of the plurality of channels:
(a) generate a usage map based on the trend dataset for that channel;
(b) generate one or more channel queries based on the usage map for that channel; and
(c) query that channel via the channel extraction interface and based on the one or more channel queries in order to receive the trend content dataset.

3. The system of claim 2, wherein the channel extraction interface is configured to, for at least one channel of the plurality of channels, request the trend dataset via an application programming interface provided by that channel.

4. The system of claim 1, wherein the one or more processors are further configured to:
(a) determine the proportionality for each of the one or more topics based on the trend measurement for that topic and the aggregated trend measurements for all of the one or more topics for that channel;
(b) determine the extraction capability for each of the plurality of channels based on one or more of:
(i) a pre-configured storage limitation of the data storage;
(ii) a data transmission limitation for communications between the channel extraction interface and that channel; and
(iii) a limitation of an application programming interface of that channel via which the trend content dataset is received.

5. The system of claim 1, wherein the one or more processors are further configured to, for each of the one or more topics from all of the plurality of channels:
(a) determine a platform breadth for that topic based on the number of the plurality of channels that topic is trending on;
(b) determine a duration for that topic based on the number of consecutive time periods for which that topic was identified as trending;
(c) determine a cultural breadth for that topic based on the number of cultural categories associated with the topic, wherein the cultural categories associated with that topic are selected from a preconfigured plurality of cultural categories;
(d) determine a seasonality for that topic based on a temporal recurrence of that trend evidenced by historic trend datasets; and
(e) determine the timeseries prediction for that trend based at least in part on the platform breadth, the duration, the cultural breadth, and the seasonality of that trend.

6. The system of claim 5, wherein the trend interface, when describing that topic, further describes the platform breadth, the duration, the cultural breadth, and the seasonality for that trend.

7. The system of claim 6, wherein the trend interface describes:
(a) the platform breadth as high or low based upon a preconfigured platform breadth threshold;
(b) the duration as emerging or persisting based upon a preconfigured platform duration threshold; and
(c) the cultural breadth as broad or niche based upon a preconfigured cultural breadth threshold.

8. The system of claim 1, wherein the one or more processors are further configured to, when determining the timeseries prediction for each of the one or more topics:
(a) evaluate one or more quantitative variables associated with that topic in the trend dataset, wherein the one or more quantitative variables includes an interaction variable that describes a magnitude of user interaction with that topic;
(b) evaluate one or more qualitative variables associated with that topic, wherein the one or more qualitative variables includes a text content associated with that topic;
(c) evaluate a historical trend dataset associated with that topic and stored by the data storage; and
(d) determine the timeseries prediction based on the evaluations of the one or more quantitative variables, the one or more qualitative variables, and the historical trend dataset for that trend.

9. The system of claim 1, wherein the one or more processors are further configured to, when determining the timeseries prediction:
(a) determine a plurality of portions of the historical trend dataset for that topic, wherein each portion corresponds to a channel of the plurality of channels;
(b) evaluate each portion of the plurality of portions against the other portions to identify a temporal relationship for that topic that describes a period of time between a change in that topic's trend on a first channel and a corresponding change in that topic's trend on a second channel; and
(c) determine the timeseries prediction further based on the identified temporal relationship.

10. The system of claim 1, wherein the one or more processors are further configured to:
(a) while creating and providing trend interface datasets over a period of time, store a plurality of trend datasets and a plurality of trend content datasets in the data storage;
(b) receive a user configured trend interest from a user;
(c) search the plurality of trend datasets and the plurality of trend content datasets based on the user configured trend interest to identify a custom trend dataset; and
(d) determine a customer timeseries prediction for the user configured trend interest based on the custom trend dataset, wherein the trend interface further describes the custom trend dataset.

11. A method for collecting and managing trend data comprising, by one or more or processors:
(a) providing a channel extraction interface configured to receive data from a plurality of channels, where the plurality of channels includes at least one social media channel;
(b) receiving a trend dataset from the plurality of channels via the channel extraction interface, wherein the trend dataset describes, for each of the plurality of channels, one or more topics that are trending on that channel, and a trend measurement for each of the one or more topics on that channel;
(c) determining a proportionality for each of the one or more topics based on the trend measurements for the one or more topics on that channel;
(d) determining an extraction capability for each of the plurality of channels;
(e) determining an extraction goal for each of the plurality of channels based on the proportionality and the extraction capability for each of the plurality of channels;
(f) for each of the plurality of channels, receiving a trend content dataset from that channel via the channel extraction interface and based on the extraction goal for that channel, and storing the trend content dataset in a data storage, wherein the trend content dataset comprises a representative sampling of content associated with the one or more trends on that channel;
(g) determining a timeseries prediction for each of the one or more topics for a subsequent period of time; and
(h) providing a trend interface dataset to a user device based on the timeseries predictions and the trend content datasets, wherein the trend interface dataset is usable to cause the user device to display a trend interface describing the timeseries predictions and the trend content datasets.

12. The method of claim 11, further comprising, for each channel of the plurality of channels:
(a) generating a usage map based on the trend dataset for that channel;
(b) generating one or more channel queries based on the usage map for that channel; and
(c) querying that channel via the channel extraction interface and based on the one or more channel queries in order to receive the trend content dataset.

13. The method of claim 12, wherein the channel extraction interface is configured to, for at least one channel of the plurality of channels, request the trend dataset via an application programming interface provided by that channel.

14. The method of claim 11, further comprising:
(a) determining the proportionality for each of the one or more topics based on the trend measurement for that topic and the aggregated trend measurements for all of the one or more topics for that channel;
(b) determining the extraction capability for each of the plurality of channels based on one or more of:
(i) a pre-configured storage limitation of the data storage;
(ii) a data transmission limitation for communications between the channel extraction interface and that channel; and
(iii) a limitation of an application programming interface of that channel via which the trend content dataset is received.

15. The method of claim 11, further comprising, for each of the one or more topics from all of the plurality of channels:
(a) determining a platform breadth for that topic based on the number of the plurality of channels that topic is trending on;
(b) determining a duration for that topic based on the number of consecutive time periods for which that topic was identified as trending;
(c) determining a cultural breadth for that topic based on the number of cultural categories associated with the topic, wherein the cultural categories associated with that topic are selected from a preconfigured plurality of cultural categories;
(d) determining a seasonality for that topic based on a temporal recurrence of that trend evidenced by historic trend datasets; and
(e) determining the timeseries prediction for that trend based at least in part on the platform breadth, the duration, the cultural breadth, and the seasonality of that trend.

16. The method of claim 15, wherein the trend interface, when describing that topic, further describes the platform breadth, the duration, the cultural breadth, and the seasonality for that trend.

17. The system of claim 16, wherein the trend interface describes:
(a) the platform breadth as high or low based upon a preconfigured platform breadth threshold;
(b) the duration as emerging or persisting based upon a preconfigured platform duration threshold; and
(c) the cultural breadth as broad or niche based upon a preconfigured cultural breadth threshold.

18. The method of claim 11, further comprising, when determining the timeseries prediction for each of the one or more topics:
(a) evaluating one or more quantitative variables associated with that topic in the trend dataset, wherein the one or more quantitative variables includes an interaction variable that describes a magnitude of user interaction with that topic;
(b) evaluating one or more qualitative variables associated with that topic, wherein the one or more qualitative variables includes a text content associated with that topic;
(c) evaluating a historical trend dataset associated with that topic and stored by the data storage; and
(d) determining the timeseries prediction based on the evaluations of the one or more quantitative variables, the one or more qualitative variables, and the historical trend dataset for that trend.

19. The method of claim 11, further comprising, when determining the timeseries prediction:
(a) determining a plurality of portions of the historical trend dataset for that topic, wherein each portion corresponds to a channel of the plurality of channels;
(b) evaluating each portion of the plurality of portions against the other portions to identify a temporal relationship for that topic that describes a period of time between a change in that topic's trend on a first channel and a corresponding change in that topic's trend on a second channel; and
(c) determining the timeseries prediction further based on the identified temporal relationship.

20. The method of claim 11, further comprising:
(a) while creating and providing trend interface datasets over a period of time, storing a plurality of trend datasets and a plurality of trend content datasets in the data storage;
(b) receiving a user configured trend interest from a user;
(c) searching the plurality of trend datasets and the plurality of trend content datasets based on the user configured trend interest to identify a custom trend dataset; and
(d) determining a customer timeseries prediction for the user configured trend interest based on the custom trend dataset, wherein the trend interface further describes the custom trend dataset.
